(19) United States
(12) Patent Application Publication
(10) Pub. No.: US 2012/0244348 A1
(43) Pub. Date: Sep. 27, 2012

(54) TOUCH PANEL

(75) Inventors: Min Soo Park, Yuseong-gu (KR); Se Woo Yang, Seo-gu (KR); Woo Ha Kim, Yuseong-gu (KR); Yoon Tae Hwang, Yuseong-gu (KR); Suk Ky Chang, Yuseong-gu (KR)

(73) Assignee: LG CHEM, LTD., Seoul (KR)

(21) Appl. No.: 13/498,539

(22) PCT Filed: Sep. 28, 2010
(86) PCT No.: PCT/KR2010/006599

§ 371 Date: Jun. 7, 2012

(30) Foreign Application Priority Data
Sep. 28, 2009 (KR) 10-2009-0092065
Sep. 27, 2010 (KR) 10-2010-0093117

(51) Int. Cl. B32B 7/12; C09J 133/10; C09J 133/08

(52) U.S. Cl. 428/355 AC; 524/560; 524/558; 428/500; 428/522

(57) ABSTRACT

The present invention relates to a touch panel. The present touch panel has a shape that comprises a plastic substrate film and a pressure sensitive adhesive layer attached to said substrate film. Here, a phenomenon of penetrating oxygen, moisture or other foreign materials into an interface between said substrate film and said pressure sensitive adhesive layer is prevented, and decrease of optical properties by bubble generation due to the out-gassing phenomenon in the plastic substrate film is prevented. In addition, even if the pressure sensitive adhesive layer is directly attached to the conductive thin film, and it is exposed to a severe condition such as high temperature or high temperature and high humidity condition as such a state, change of resistance in the conductive thin film is effectively inhibited. Therefore, the present touch panel may be stably driven for a long time.

### DESCRIPTION

1. Technical Field

The present invention relates to a touch panel, and a pressure sensitive adhesive composition and a pressure sensitive adhesive sheet, applied to the touch panel.

2. Background Art

A touch panel is also called as a touch screen and applied to various information processing terminals such as mobile communication terminals and ATM or displays such as TV or monitors. As the touch panel is increasingly used in small portable electronic devices, and the like, demand for small and lightweight touch panels is on the rise.

According to the above trend, the touch panel is increasingly configured by forming a transparent conductive thin film on a transparent plastic film with indium tin oxide (ITO) and using the resulting film.

In a process of configuring the touch panel in a shape having the plastic film as above, a pressure sensitive adhesive is used to attach said plastic film to other film or substrate, and the like. In a pressure sensitive adhesive used in configuring such touch panel, physical properties are required, which may maintain transparency under a severe condition such as high temperature or high temperature and high humidity condition and inhibit looseness, detachment and warpage. In addition, the plastic film causes so-called out-gassing phenomenon that moisture, solvent or other liquid phase additives present inside in heat resistant condition are emitted to a gaseous state, and this emitted gas causes bubbles, so that visibility is easily lowered. Therefore, it is also required in the pressure sensitive adhesive to effectively inhibit the bubble generation.

Furthermore, in the process of configuring the touch panel, most of pressure sensitive adhesive layers are directly attached to a conductive thin film such as a thin film of indium tin oxide. Accordingly, the pressure sensitive adhesive layer also requires a characteristic that the panel drive may be stably carried out even in a prolonged period use by inhibiting change of resistance in the conductive thin film.

### DISCLOSURE

### Technical Problem

The present invention is intended to provide a touch panel, and a pressure sensitive adhesive composition and a pressure sensitive adhesive sheet, applied to the touch panel.

### Technical Solution

The present invention relates to a touch panel comprising a plastic substrate film; and a pressure sensitive adhesive layer, wherein the adhesive layer is attached to said substrate film and comprises an acrylic resin having the polydispersity index of 4.0 or less.

The present invention is explained in detail below.

As long as the present touch panel has a shape having a plastic substrate film, it is not particularly limited to any kind For example, the present touch panel may be a resistance type touch panel or a capacitance type touch panel.

In the resistance type touch panel having a plastic substrate film, a transparent plastic film, one side of which a transparent conductive thin film is formed on; and a glass or plastic film, one side of which a transparent conductive film is also formed on, are used, for example, as upper and bottom base, respectively. In the resistance type touch panel, a spacer is formed between transparent conductive thin films formed on said upper and bottom base materials, respectively. When the touch panel is pressed by a pen or a hand for said two conductive thin films to be in contact with each other, it realizes the touch, as an electric current runs.

In the capacitance type touch panel having a plastic substrate film, two base, at least one side of which transparent conductive thin film is formed on, configure a capacitor by attaching said transparent conductive thin films among themselves with a pressure sensitive adhesive layer. At least one base in the above two base materials comprises a plastic substrate film and the touch is realized by change of capacitance with touching.

A unitary component comprising a resistance type or conductance type touch panel is variously present, but the basic unit is as shown in FIG. 1 or 2.

FIG. 1 represents a structure (1) that a base (13), one side of which a hard coating (12) is formed on, and a substrate film (14) are attached via a pressure sensitive adhesive layer (11). In the structure of FIG. 1, the base (13) and the substrate film (14) may be a plastic substrate film. Furthermore, FIG. 2 represents a structure (2) applied to a capacitance type touch panel, which has a shape that base (23, 24), one side of which conductive thin films (21, 22) each are formed on, are attached via a pressure sensitive adhesive layer (11). In the structure of FIG. 2, an upper base material (23) or a bottom base material (24) may be a plastic substrate film.

The present touch panel has a structure comprising a plastic substrate film and a pressure sensitive adhesive layer attached to said substrate film and, for example, may comprise the structure of FIG. 1 or 2. When the present touch panel comprises the structure of FIG. 1 or 2, said plastic substrate film may be the base (13) or the substrate film (14) of FIG. 1, or the upper or bottom base (23 or 24) of FIG. 2.

In one aspect of the present invention, the touch panel may be a capacitance type touch panel, wherein a conductive thin film (21) may be formed on at least one side of said plastic substrate film (23) and said pressure sensitive adhesive layer (11) may be directly attached to said conductive thin film (21), as in FIG. 2.

The capacitance type touch panel further comprises a base (24), one side of which a conductive thin film (22) is formed on, wherein it may have a shape that the conductive thin film (22) of said base (24) and the conductive thin film (21) of said plastic substrate film (23) are attached to each other by said pressure sensitive adhesive layer (11).

The plastic substrate film included in the present touch panel is not particularly limited to any kind As long as the plastic substrate film herein has transparency, it can be used without limitation. Specifically, a polyester film, an acrylic resin film, a polycarbonate film, a polyamide film, a polyvinyl chloride film, a polystyrene film or a polyolefin film, and the like may be used, and preferably, a polyester film such as polyethylene terephthalate or a polycarbonate film, and the like may be used.

A thickness of the plastic substrate film as above herein is not particularly limited, and may be suitably set depending on positions to which the substrate film is applied. For example, said substrate film may have a thickness of about 3 μm to 300 μm, preferably about 5 μm to 250 μm and more preferably, 10 μm to 200 μm.

In addition, the plastic substrate film or the conductive thin film formed on base materials may be formed by, for example, a vacuum vapor deposition method, a sputtering method, an ion plating method, a spray pyrolysis method, a chemical plating method, an electroplating method or a thin film formation method in combination with at least two methods thereof, and preferably a vacuum vapor deposition method or a sputtering method.

As a raw material consisting of the conductive thin film, a metal such as gold, silver, platinum, palladium, copper, aluminum, nickel, chrome, titanium, iron, cobalt, tin and an alloy of at least two metals thereof, indium oxide, tin oxide, titanium oxide, cadmium oxide or metal oxides composed of at least two mixtures thereof, or other metal oxides composed of copper iodide, and the like may be used. Said conductive thin film may be a crystalline layer or an amorphous layer. Preferably, the conductive thin film herein may be formed by using indium tin oxide (ITO), without being limited thereto. In addition, the thickness of the conductive thin film as above may be controlled in a range of about 10 nm to 300 nm, and preferably, about 10 nm to 200 nm, considering possibility for forming a continuous coat, conductivity and transparency, and the like.

The conductive thin film herein may be also formed on the plastic substrate film or the base material via an anchor layer or a dielectric layer. The anchor layer or the dielectric layer can improve adhesion between the conductive thin film and the substrate film or the base material and scratch resistance or flex resistance. The anchor layer or the dielectric layer may be formed by using, for example, inorganic materials such as SiO₂, MgF₂ or Al₂O₃, and the like; organic materials such as an acrylic resin, a urethane resin, a melamine resin, an alkyd resin or a siloxane polymer or a mixture of at least two thereof, wherein as a forming method, for example, a vacuum vapor deposition method, a sputtering method, an ion plating method or a pottery method may be adapted. The anchor layer or the dielectric layer may be formed in a thickness of usually about 100 nm or less, particularly 15 nm to 100 nm, and more particularly 20 nm to 60 nm.

An appropriate adhesion treatment such as a corona discharge treatment, an ultraviolet irradiation treatment, a plasma treatment or a sputter etching treatment may be also carried out on the substrate film or the base material side on which the conductive thin film is formed.

Furthermore, a hard coating layer (12) in the structure as shown in FIG. 1 may be formed by a process of applying a hard resin such as acrylic urethane resin or siloxane resin and hardening it and usually have a thickness of 0.1 μm to 30 μm.

The present touch panel comprises a pressure sensitive adhesive layer comprising an acrylic resin having the polydispersity index (PDI) of 4.0 or less, wherein said pressure sensitive adhesive layer is attached to said plastic substrate film or a conductive thin film forming on said plastic substrate film. The polydispersity index herein is a value (M_{w}/Mₙ) that a weight average molecular weight (M_{w}) of acrylic resin is divided by a number average molecular weight (Mₙ) thereof. The weight average molecular weight and the number average molecular weight can be measured by Gel Permeation Chromatography (GPC). The acrylic resin herein may have the polydispersity index of, preferably, 3.5 or less, and more preferably, 3.0 or less. By using the acrylic resin having a polydispersity index of 4.0 or less, free volume in the pressure sensitive adhesive layer is suitably regulated, whereby a phenomenon of lowering visibility or other optical properties by penetrating oxygen, moisture or other foreign materials into an interface between the pressure sensitive adhesive layer and an adherend, or generating bubbles from an adherent interface by the out-gassing phenomenon in the plastic substrate film, may be effectively prevented. In particular, when the pressure sensitive adhesive layer is directly attached to the conductive thin film, said pressure sensitive adhesive layer may effectively inhibit change of resistance in the conductive thin film even though it is exposed to a severe condition. Therefore, the touch panel may be stably driven for a long time. As the polydispersity index of said resin herein have lower value, so does the free volume in the pressure sensitive adhesive decrease to improve the effects as mentioned above. Therefore, the lower limit is not particularly limited, but it may be, for example, at least about 0.5, preferably, at least 1.0, more preferably at least 1.5, and most preferably at least 2.0.

Said acrylic resin herein may have a weight average molecular weight of 300,000 to 1,500,000, preferably 400,000 to 1,200,000, and more preferably 500,000 to 800,000. It the weight average molecular weight of the resin is too low, endurance may be decreased. If it is too high, workability such as coating ability may be decreased or warpage resistance may be lowered. Therefore, it is preferred to control it in the aforementioned range.

In one aspect of the present invention, the acrylic resin may comprise a (meth)acrylic acid ester monomer and a copolymerizable monomer that can provide the acrylic resin with a crosslinkable functional group in a polymerized form.

The (meth)acrylic acid ester monomer above is not particularly limited to any kind, but, for example, alkyl(meth)acrylate may be used and considering physical properties such as cohesive attraction, glass transition temperature and stickiness, alkyl(meth)acrylate having an alkyl group with 1 to 14 carbon atoms may be used. Examples of such alkyl(meth)acrylate may include methyl(meth)acrylate, ethyl(meth)acrylate, n-propyl(meth)acrylate, isopropyl(meth)acrylate, butyl(meth)acrylate, t-butyl(meth)acrylate, pentyl(meth)acrylate, 2-ethylhexyl(meth)acrylate, n-octyl(meth)acrylate, isooctyl(meth)acrylate, isononyl(meth)acrylate, lauryl(meth)acrylate and tetradecyl(meth)acrylate, and the like, wherein the resin may comprise one or two or more thereof in a polymerized form.

The copolymerizable monomer providing with a crosslinkable functional group may provide the resin with a crosslinkable functional group that can react with a multi-functional crosslinker Examples of such crosslinkable functional group may include a hydroxyl group, a carboxyl group, a nitrogenous group, an epoxy group or an isocyanate group, and the like, and it may be, preferably, a hydroxyl group, a carboxyl group or a nitrogenous group. In a field of preparing acrylic resins, various copolymerizable monomers that can provide the resin with a crosslinkable functional group as above are known, wherein the monomer as above may be used without limitation. For example, as a copolymerizable monomer having a hydroxyl group, 2-hydroxyethyl (meth)acrylate, 2-hydroxypropyl (meth)acrylate, 4-hydroxybutyl(meth)acrylate, 6-hydroxyhexyl(meth)acrylate, 8-hydroxyoctyl(meth)acrylate, 2-hydroxyethyleneglycol(meth)acrylate or 2-hydroxypropyleneglycol(meth)acrylate, and the like may be used; as a copolymerizable monomer having a carboxyl group, (meth)acrylic acid, 2-(meth)acryloyloxy acetic acid, 3-(meth)acryloyloxy propionic acid, 4-(meth)acryloyloxy butyric acid, acrylic acid dimer, itaconic acid, maleic acid or maleic anhydride, and the like may be used; and as a copolymerizable monomer having a nitrogenous group, (meth)acrylamide, N-vinyl pyrrolydone or N-vinyl caprolactam, and the like may be used, without limiting thereto.

The acrylic resin herein may comprise 90 to 99.9 parts by weight of a (meth)acrylic acid ester monomer and 0.1 to 10 parts by weight of a copolymerizable monomer providing with a crosslinkable functional group in a polymerized unit. The unit “part by weight” herein means a ratio by weight. By controlling ratios by weight of monomers in the above range, physical properties of the pressure sensitive adhesive layer such as initial adhesion strength, endurance and peel force may be effectively maintained.

The present acrylic resin may further comprise, if appropriate, a comonomer represented by the following Formula 1 in a polymerized form. Said comonomer may be included for purpose of controlling glass transition temperature or giving other functions.

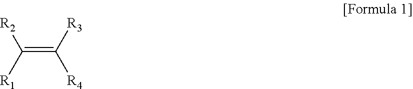

wherein, R₁ to R₃ each represents independently hydrogen or alkyl with 1 to 4 carbon atoms, R₄ represents cyano; phenyl unsubstituted or substituted by alkyl with 1 to 4 carbon atoms; acetyloxy; or —C(═O)R₅, where R₅ represents amino or glycidyloxy unsubstituted or substituted by alkyl with 1 to 4 carbon atoms or alkoxyalkyl with 2 to 8 carbon atoms.

Specific examples of the comonomer of Formula 1 may include a nitrogenous monomer such as (meth)acrylonitrile, N-methyl(meth)acrylamide or N-butoxy methyl(meth)acrylamide; a styrene monomer such as styrene or methyl styrene; glycidyl(meth)acrylate; or vinyl ester of carboxylic acid such as vinyl acetate, and the like, but are not limited thereto.

When the comonomer of Formula 1 is included in the resin, it is preferred that the ratio is 20 parts by weight or less, but not limited thereto.

The acrylic resin as above herein may be prepared by a usual polymerization manner in this field, for example, solution polymerization, photo polymerization, bulk polymerization, suspension polymerization or emulsion polymerization manners, and preferably a solution polymerization manner In addition, said polymerization may be also carried out in the presence of a suitable chain transfer agent (CTA), for example, 2-mercaptoethanol, lauryl mercaptan, glycidyl mercaptan, mercaptoacetic acid, 2-ethylhexylthioglycolate, 2,3-dimercapto-1-propanol and α-methyl-styrene dimer, and the like.

Said acrylic resin included in the present touch panel may be present in a state crosslinked by a multi-functional crosslinker. That is, said pressure sensitive adhesive layer may further comprise a multi-functional crosslinker which crosslinks said acrylic resin.

The usable crosslinker herein is not particularly limited to any kind, and, for example, an isocyanate compound, an epoxy compound, an aziridine compound or a metal chelate compound, and the like may be used, which may be suitably selected from one or two or more crosslinkers, considering the kind of the crosslinkable functional group included in the resin. The isocyanate compound may be tolylene diisocyanate, xylene diisocyanate, diphenylmethane diisocyanate, hexamethylene diisocyanate, isophorone diisocyanate, tetramethylxylene diisocyanate or naphthalene diisocyanate, and the like. Also, the isocyanate compound may be an addition reaction product of at least one foregoing isocyanate compound and a polyol. Here, as the polyol, trimethylolpropane may be used. As the epoxy compound, one or two or more from ethyleneglycol diglycidylether, triglycidylether, trimethylolpropane triglycidylether, N,N,N′,N′-tetraglycidyl ethylenediamine or glycerin diglycidylether, and the like may be used, and as the aziridine compound, one or two or more from N,N′-toluene-2,4-bis(1-aziridinecarboxamide), N,N′-diphenylmethane-4,4′-bis(1-aziridinecarboxamide), triethylenemelamine, bisisophthaloyl-1-(2-methylaziridine) or tri-1-aziridinylphosphineoxide, and the like may be used. In addition, as the metal chelate compound, a compound present in a state that a polyvalent metal is coordinated with acetyl acetone or ethyl acetoacetate, and the like may be used, wherein the polyvalent metal includes aluminum, iron, zinc, tin, titanium, antimony, magnesium or vanadium, and the like.

The multi-functional crosslinker in the present pressure sensitive adhesive layer may be included in an amount of 0.01 to 5 parts by weight relative to 100 parts by weight of an acrylic resin, wherein it can effectively regulate endurance and adhesion properties of the pressure sensitive adhesive layer in this range.

The present pressure sensitive adhesive layer may further comprise one or two or more of additives such as a silane coupling agent; a tackifier; an epoxy resin; a ultraviolet light stabilizer; an antioxidant; a toning agent; a reinforcing agent; a filler; a defoamer; a surfactant or a plasticizer, in addition to the aforementioned components.

The pressure sensitive adhesive layer as above herein may be formed by subjecting a pressure sensitive adhesive composition combined from components such as the aforementioned acrylic resin and a multi-functional crosslinker to suitable dryness, ageing, crosslinking and/or hardening processes.

The present invention relates to a pressure sensitive adhesive composition for a touch panel comprising an acrylic resin having a polydispersity index of 4.0 or less, which is satisfied with a condition of the following general formula 1.

ΔR=[(R−Rᵢ)/Rᵢ]×100≦15 [General Formula 1]

wherein, ΔR represents a resistance change rate, Rᵢ represents an initial resistance of an ITO electrode measured after a pressure sensitive adhesive layer derived from said pressure sensitive adhesive composition is attached to the ITO electrode, R is a resistance of said ITO electrode measured after the ITO electrode, to which said pressure sensitive adhesive layer is attached, is maintained at 60° C. and 90% relative humidity for 240 hours.

The term “a pressure sensitive adhesive layer derived from a pressure sensitive adhesive composition” means a pressure sensitive adhesive layer that is prepared as pressure sensitive adhesive by subjecting the pressure sensitive adhesive composition to a drying process, aging process, a crosslinking process and/or a curing process, and that is applied to a touch panel.

The pressure sensitive adhesive composition for a touch panel according to the present invention may be, for example, for being applied to a touch panel having a structure as mentioned above, and specifically, for being applied to said pressure sensitive adhesive layer in the touch panel comprising a plastic substrate film and a pressure sensitive adhesive layer attached to said substrate film.

Any component to constitute the pressure sensitive adhesive composition for a touch panel according to the present invention is not particularly limited, and may comprise, for example, an acrylic resin having the polydispersity index of 4.0 or less, preferably 3.5 or less, more preferably 3.0 or less, if appropriate, together with a multi-functional crosslinker and/or other additives.

The present pressure sensitive adhesive composition comprises an acrylic resin having a polydispersity index of 4.0 or less. Therefore, it can effectively meet various physical properties required for the touch panel. Also, even if it is applied to a touch panel having a shape that a pressure sensitive adhesive layer is directly attached to a conductive thin film, it can effectively inhibit change of resistance in said conductive thin film.

Specifically, the present pressure sensitive adhesive composition may have a resistance change rate (ΔR) of general formula 1 of 15% or less, preferably 10% or less. Said resistance change rate herein is measured by a method described in the following examples. In addition, as said resistance change rate has a low value, so is the stable drive of the touch panel secured, without limiting the lower limit

Furthermore, the present invention relates to a pressure sensitive adhesive sheet, for a touch panel, having a pressure sensitive adhesive layer comprising a pressure sensitive adhesive composition according to the present invention. The pressure sensitive adhesive layer in the present pressure sensitive adhesive sheet may comprise said pressure sensitive adhesive composition in a state of drying, ageing, crosslinking and/or hardening.

FIG. 3 represents a pressure sensitive adhesive sheet (3) according to one aspect of the present invention, wherein said pressure sensitive adhesive sheet (3) may further comprise said pressure sensitive adhesive layer (31) and release films (32, 33) formed on both sides thereof.

When the pressure sensitive adhesive sheet comprises a release film, peel force to two sheets of release film included in the pressure sensitive adhesive layer may be differently set to each other. For example, in the structure represented in FIG. 3, peel force of the pressure sensitive adhesive layer (31) to one release film (33) may be set higher than one of the pressure sensitive adhesive layer (31) to other release film (32). The pressure sensitive adhesive sheet having such structure may be formed by selecting an appropriate kind of release film or regulating cure degree of the pressure sensitive adhesive layer (31).

The specific release film as above herein is not particularly limited to any kind, and various release films disclosed in this field may be used without limitation, the thickness of which may be regulated to, for example, about 5 to 150 μm.

The method of forming the pressure sensitive adhesive layer as above and preparing the pressure sensitive adhesive sheet herein is not particularly limited. For example, the pressure sensitive adhesive may be prepared by coating the present pressure sensitive adhesive composition or a coating liquid, the viscosity of which is regulated by diluting the composition in a suitable solvent, on a release film and curing it to form a pressure sensitive adhesive layer, and laminating other release film thereto. In addition, although said coating is not always carried out on the release film, it may be also carried out on other substrates. Also, the curing process of the coated coating liquid may be carried out by drying the coating layer under a suitable condition and, optionally, a process may be also carried out, which crosslinks the acrylic resin included in the pressure sensitive adhesive composition with a multi-functional crosslinker after or simultaneously with said dry process by a manner such as heating. However, although the crosslinking process is not always carried out in a procedure of forming the pressure sensitive adhesive layer, it may be also carried out in any procedure applied to the touch panel.

For example, if the pressure sensitive adhesive sheet is applied to the touch panel as mentioned above, said pressure sensitive adhesive layer may be applied to a plastic substrate film or a conductive thin film formed on the film to crosslink the acrylic resin via an appropriate crosslinking treatment.

### Advantageous Effects

The present touch panel has a shape that comprises a plastic substrate film and a pressure sensitive adhesive layer attached to said substrate film. Here, a phenomenon of penetrating oxygen, moisture or other foreign materials into an interface between said substrate film and said pressure sensitive adhesive layer is prevented, and decrease of optical properties by bubble generation due to the out-gassing phenomenon in the plastic substrate film is prevented. In addition, even if the pressure sensitive adhesive layer is directly attached to the conductive thin film, and it is exposed to a severe condition such as high temperature or high temperature and high humidity condition as such a state, change of resistance in the conductive thin film is effectively inhibited. Therefore, the present touch panel may be stably driven for a long time.

### DESCRIPTION OF DRAWINGS

FIGS. 1 and 2 are drawings that represent structure of touch panels according to one aspect of the present invention.

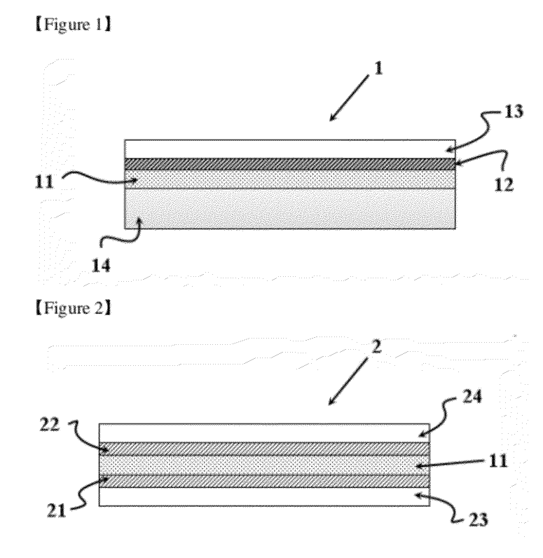

FIG. 3 is a drawing that represents a pressure sensitive adhesive sheet according to one aspect of the present invention.

FIG. 4 is a drawing that explains a method of measuring resistance change rate herein.

### MODE FOR INVENTION

The present invention is explained in more detail via examples according to the present invention and comparative examples not according to the present invention below, the scope of which is not restricted to the following examples.

Each physical property in the present examples was evaluated by the following methods.

### 1. Endurance Test

A hard coating side of a polyethylene terephthalate film that has the thickness of 100 μm, and on both sides of which hard coatings are formed is attached to a polycarbonate sheet that has the thickness of 1 mm by using a pressure sensitive adhesive layer, and tailored in a size of 50 mm×100 mm (width×length). Subsequently, the tailored attachment is subjected to autoclave at 60° C. and 5 atmospheres for 30 minutes to prepare a sample, for which the heat resistance endurance and the heat and moisture resistance endurance are evaluated. The heat resistance endurance is measured by leaving the sample at 80° C. for 240 hours, and then evaluating the generation of bubbles, looseness, peel-off and/or warpage. Also, the heat and moisture resistance endurance is measured by leaving the sample at 60° C. and 90% relative humidity for 240 hours, and then evaluating the generation of bubbles, looseness, peel-off and warpage. Specific measuring method or basis of each physical property above, which is index of endurance, is as follows.

<Evaluation of Bubble Generation>

∘:In case where no bubble is generated in the interface of adhesion or a small amount of bubbles having a diameter of 100 μm an or less are dispersed therein when observing with an optical microscope

×: In case where a bubble having a diameter of 100 μm or more is generated in the interface of adhesion or a large amount of bubbles having a diameter of 100 μm or less are observed in a group state when observing with an optical microscope

<Evaluation of Looseness and Peel-Off>

∘:In case where no looseness and peel-off is occurred in the interface of adhesion

×:In case where looseness or peel-off is occurred in the interface of adhesion

<Evaluation of Warpage>

When the sample that had been left under the heat resistant condition or the heat and moisture resistant condition was placed on a floor, height of its center spaced from the floor by warping was measured.

### 2. Test of Resistance Change Rate

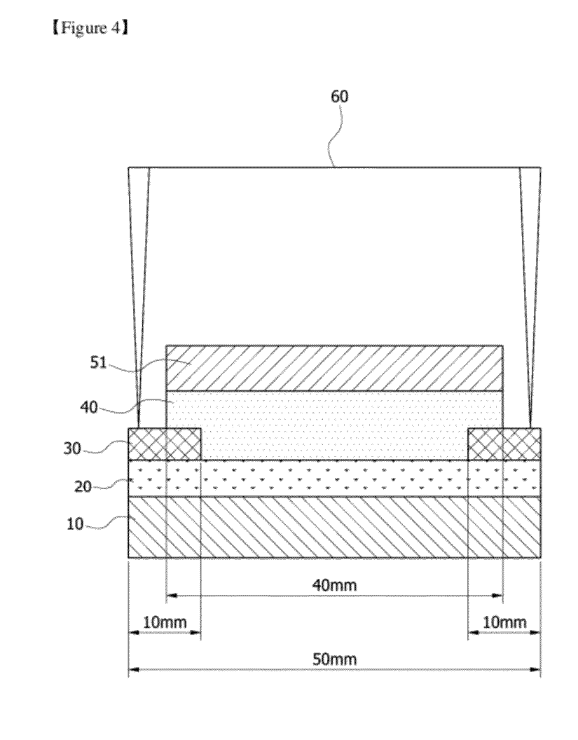

The resistance change rate is measured by a method as represented in FIG. 4. First, a polethyleneterephthalate film (10) (hereinafter, referred to “conductive PET”) as generally distributed in this field, wherein an ITO thin film (20) is formed on one side, is tailored in a size of 30 mm×50 mm (width×length). Subsequently, after silver paste (30) is applied to both ends of the film (10) with a width of 10 mm as in FIG. 4, the film is baked at 150° C. for 30 minutes. Then, a pressure sensitive adhesive sheet as prepared in examples, and the like, wherein release films (51) are attached to both sides, is tailored in a size of 30 mm×40 mm (width×length), and following removing one side of the release films, the obtained pressure sensitive adhesive layer (40) is attached to the baked film. Said attaching is carried out with adjusting the centers of the pressure sensitive adhesive layer and the conductive PET (10, 20). Then, using a conventional ohmmeter (60), the initial resistance (Rᵢ) of the ITO thin film (20) is measured. After measuring the initial resistance, the specimen of FIG. 4 is left at 60° C. and 90% relative humidity for 240 hours, and the resistance (R) of the ITO thin film (20) is again measured by the ohmmeter (60). Each value is substituted in the following formula 1 to measure the resistance change rate (ΔR).

ΔR=[(R−Rᵢ)/Rᵢ]×100 [Mathematical Formula 1]

### PREPARATION EXAMPLE 1

### Preparation of Acrylic Resin (A)

97 Parts by weight of n-butyl acrylate (n-BA) and 3 parts by weight of acrylic acid (AA) were introduced into a 1 L reactor in which nitrogen gas was refluxed inside and to which a cooler is installed in order to easily regulate temperature. Subsequently, 120 parts by weight of ethyl acetate (EAc) was introduced thereto as a solvent and 0.03 parts by weight of 2-mercapto ethanol as a chain transfer agent was introduced thereto. Then, to remove oxygen, nitrogen gas was purged for 60 minutes, and in a state for a temperature to be maintained at 60° C., 0.04 parts by weight of azobisisobutyronitrile (AIBN), which was an initiator for reaction, was introduced thereto, followed by reacting the mixture for 8 hours. After the reaction, the reactant was suitably diluted with ethyl acetate (EAc) to prepare an acrylic resin (A) having a solid content of 30% by weight, a weight average molecular weight of 800,000 and the polydispersity index (M_{w}/Mₙ) of 2.7. Here, the weight average molecular weight and the polydispersity index of the resin were measured through GPC analysis generally used in the polymer field.

### PREPARATION EXAMPLE 2

### Preparation of Acrylic Resin (B)

An acrylic resin (B) was prepared by a method in accordance with Preparation Example 1, except that 93 parts by weight of n-butyl acrylate (n-BA) and 7 parts by weight of acrylic acid as monomers were introduced in the reactor. The acrylic resin (B) had a solid content of 30% by weight, a weight average molecular weight of 850,000 and the polydispersity index of 2.8.

### PREPARATION EXAMPLE 3

### Preparation of Acrylic Resin (C)

An acrylic resin (C) was prepared by a method in accordance with Preparation Example 1, except that 98.5 parts by weight of n-butyl acrylate (n-BA) and 1.5 parts by weight of 2-hydroxyethyl methacrylate (2-HEMA) as monomers were introduced in the reactor. The acrylic resin (C) had a solid content of 30% by weight, a weight average molecular weight of 700,000 and the polydispersity index of 2.3.

### PREPARATION EXAMPLE 4

### Preparation of Acrylic Resin (D)

An acrylic resin (D) was prepared by a method in accordance with Preparation Example 1, except that 68.5 parts by weight of n-butyl acrylate (n-BA), 30 parts by weight of methyl acrylate (MA) and 1.5 parts by weight of 2-hydroxyethyl methacrylate (2-HEMA) as monomers were introduced in the reactor. The acrylic resin (D) had a solid content of 30% by weight, a weight average molecular weight of 600,000 and the polydispersity index of 2.7.

### PREPARATION EXAMPLE 5

### Preparation of Acrylic Resin (E)

An acrylic resin (E) was prepared by a method in accordance with Preparation Example 1, except that 68.5 parts by weight of n-butyl acrylate (n-BA), 30 parts by weight of methyl acrylate (MA) and 1.5 parts by weight of 2-hydroxyethyl methacrylate (2-HEMA) as monomers were introduced and 0.01 parts by weight of 2-mercaptoethanol as a chain transfer agent was introduced in the reactor. The acrylic resin (E) had a solid content of 30% by weight, a weight average molecular weight of 1,100,000 and the polydispersity index of 3.7.

### PREPARATION EXAMPLE 6

### Preparation of Acrylic Resin (F)

The polymerization was carried out by the same method as Preparation Example 1, except that in 3 hours after the initiator was introduced, the reaction temperature was raised to 68° C. and the reaction was carried out. The acrylic resin (F) having a solid content of 35% by weight, a weight average molecular weight of 770,000 and the polydisperstity index of 7.5 was prepared.

### PREPARATION EXAMPLE 7

### Preparation of Acrylic Resin (G)

An acrylic resin (G) was prepared by a method in accordance with Preparation Example 1, except that 98.5 parts by weight of n-butyl acrylate (n-BA) and 1.5 parts by weight of 2-hydroxyethyl methacrylate (2-HEMA) as monomers were introduced in the reactor and the reaction temperature was controlled to 68° C. The acrylic resin (G) had a solid content of 33% by weight, a weight average molecular weight of 800,000 and the polydispersity index of 4.5.

### EXAMPLE 1

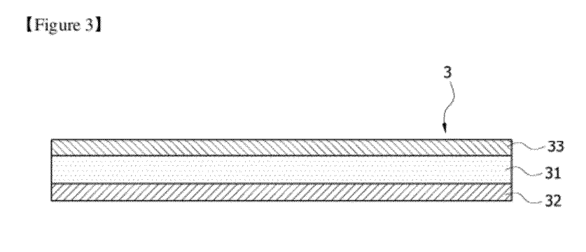

A pressure sensitive adhesive composition was prepared by homogeneously mixing the resin (A) of Preparation Example 1 and an epoxy cross-linker (Tetrad C; tetrafunctional epoxy cross-linker from Mitsubishi) in an amount of 0.1 parts by weight of the cross-linker relative to 100 parts by weight of solid content of the resin (A). Subsequently, said pressure sensitive adhesive composition was coated on the release treated side of a polyethyleneterephthalate film (50 μm thick) which was subjected to a release treatment on one side and treated at 120° C. for 3 minutes to form a transparent pressure sensitive adhesive layer having a thickness of 50 μm. Then, the release treated side of the polyethyleneterephthalate film (50 μm thick) which was subjected to a release treatment was laminated to other side of said pressure sensitive adhesive layer to prepare a pressure sensitive adhesive sheet having a structure represented in FIG. 3.

### EXAMPLE 2

The pressure sensitive adhesive sheet was prepared by the same method as Example 1, except for using the resin (B) of Preparation Example 2.

### EXAMPLE 3

The pressure sensitive adhesive sheet was prepared by the same method as Example 1, except that the acrylic resin (C) of Preparation Example 3 was used and 0.3 parts by weight of an isocyanate cross-linker (Coronate-L) as a cross-linker was mixed relative to 100 parts by weight of solid content in the resin (C).

### EXAMPLE 4

The pressure sensitive adhesive sheet was prepared by the same method as Example 1, except that the acrylic resin (D) of Preparation Example 4 was used and 0.3 parts by weight of an isocyanate cross-linker (Coronate-L) as a cross-linker was mixed relative to 100 parts by weight of solid content in the resin.

### EXAMPLE 5

The pressure sensitive adhesive sheet was prepared by the same method as Example 1, except for using the resin (E) of Preparation Example 5.

### COMPARATIVE EXAMPLE 1

The pressure sensitive adhesive sheet was prepared by the same method as Example 1, except for using the resin (F) of Preparation Example 6.

Comparative Example 2

The pressure sensitive adhesive sheet was prepared by the same method as Example 1, except that the acrylic resin (G) of Preparation Example 7 was used and 0.3 parts by weight of an isocyanate cross-linker (Coronate-L) as a cross-linker was mixed relative to 100 parts by weight of solid content in the resin.

Results of endurance test and resistance change rate test measured for each example and comparative example above are represented in the following Table 1.

TABLE 1

| | | | | | | | Comparative | |
|---|---|---|---|---|---|---|---|---|
| | | Example | | | | | Example | |
| | | 1 | 2 | 3 | 4 | 5 | 1 | 2 |
| Acrylic | Kind | A | B | C | D | E | F | G |
| Resin | M_{w}(10,000) | 80 | 85 | 70 | 60 | 110 | 77 | 80 |
| | PDI | 2.7 | 2.8 | 2.3 | 2.7 | 3.7 | 7.5 | 4.5 |

| | | | | | | | |
|---|---|---|---|---|---|---|---|
| Bubble Occurring | ∘ | ∘ | ∘ | ∘ | ∘ | ∘ | ∘ |
| Resistance | | | | | | | |
| Looseness/Peel-off | ∘ | ∘ | ∘ | ∘ | ∘ | ∘ | ∘ |
| Evaluation | | | | | | | |
| Warpage | 0.6 | 0.7 | 0.6 | 0.6 | 1.2 | 0.8 | 0.7 |
| Evaluation (mm) | | | | | | | |
| Resistance Change | 7 | 8 | 3.8 | 4 | 8.5 | 23 | 18 |
| Rate (%) | | | | | | | |

M_{w}: Weight Average Molecular Weight
PDI: Polydispersity Index

As can be seen from the results of Table 1, when the touch panel comprises a pressure sensitive adhesive layer having the polydispersity index of 4.0 or less in accordance with examples of the present invention, all effects of inhibiting bubble generation, looseness, peel-off and warpage, which are required in the touch panel, are excellent, and especially the change in resistance of electrodes is effectively inhibited.

### [Description of References]

| | |
|---|---|
| 1, 2: Touch panel structure | |
| 11: Pressure sensitive adhesive layer | |
| 13, 14, 23, 24: Base materials | |
| 12, 21, 22: Conductive thin film | |
| 3: Pressure sensitive adhesive sheet | |
| 31: Pressure sensitive adhesive layer | 32, 33: Release film |
| 10: PET film | 20: ITO thin film |
| 30: Silver paste | |
| 40: Pressure sensitive adhesive layer | |
| 51: Release film | 60: Ohmmeter |

1. A touch panel comprising:
a plastic substrate film; and
a pressure sensitive adhesive layer that is attached to said substrate film and includes an acrylic resin of which the polydispersity index is 4.0 or less.

2. The touch panel according to claim 1, wherein a conductive thin film is further formed on at least one side of the plastic substrate film and said pressure sensitive adhesive layer is directly attached to said conductive thin film.

3. The touch panel according to claim 2, wherein the touch panel further comprises a base film, at least one side of which a conductive thin film is formed on, and said pressure sensitive adhesive layer is attached to the conductive thin film of said base film and the conductive thin film of said plastic substrate film.

4. The touch panel according to claim 1, wherein the acrylic resin has the polydispersity index of 3.5 or less.

5. The touch panel according to claim 1, wherein the acrylic resin has the polydispersity index of 3.0 or less.

6. The touch panel according to claim 1, wherein the acrylic resin has a weight average molecular weight of 300,000 to 1,500,000.

7. The touch panel according to claim 1, wherein the acrylic resin comprises a (meth)acrylic acid ester monomer and a copolymerizable monomer that provides the acrylic resin with a cross-linkable functional group in a polymerized form.

8. The touch panel according to claim 7, wherein the cross-linkable functional group is a hydroxy group, a carboxyl group, a functional group containing nitrogen, an epoxy group or an isocyanate group.

9. The touch panel according to claim 1, wherein the pressure sensitive adhesive layer further comprises a multi-functional cross-linker that cross-links the acrylic resin.

10. The touch panel according to claim 9, wherein the multi-functional cross-linker is an isocyanate compound, an epoxy compound, an aziridine compound or a metal chelate compound.

11. The touch panel according to claim 9, wherein the pressure sensitive adhesive layer comprises 0.01 to 5 parts by weight of the multi-functional cross-linker, relative to 100 parts by weight of the acrylic resin.

12. A pressure sensitive adhesive composition for a touch panel that comprises an acrylic resin having the polydispersity index of 4.0 or less, and that is satisfied with a condition of the following general formula 1:
ΔR=[(R−Rᵢ)/Rᵢ]×100≦15 [General Formula 1]
wherein, ΔR represents a resistance change rate, Rᵢ represents an initial resistance of an ITO electrode measured after a pressure sensitive adhesive layer derived from said pressure sensitive adhesive composition is attached to the ITO electrode, R is a resistance of said ITO electrode measured after the ITO electrode, to which said pressure sensitive adhesive layer is attached, is maintained at 60° C. and 90% relative humidity for 240 hours.

13. The pressure sensitive adhesive composition for a touch panel according to claim 12, wherein ΔR is 10 or less.

14. The pressure sensitive adhesive composition for a touch panel according to claim 12, wherein the touch panel comprises a plastic substrate film and a pressure sensitive adhesive layer attached to said substrate film, and wherein the composition is applied to the pressure sensitive adhesive layer of the touch panel.

15. A pressure sensitive adhesive sheet for a touch panel, which has a pressure sensitive adhesive layer comprising a pressure sensitive adhesive composition according to claim 12.
